(19) United States
(12) Patent Application Publication
(10) Pub. No.: US 2025/0196736 A1
(43) Pub. Date: Jun. 19, 2025

(54) VEHICLE DOOR GUARD

(71) Applicant: 4Knines, LLC, Oklahoma City, OK (US)

(72) Inventor: James Umlauf, Glendale, AZ (US)

(21) Appl. No.: 19/068,303

(22) Filed: Mar. 3, 2025

Related U.S. Application Data
(63) Continuation-in-part of application No. 17/834,670, filed on Jun. 7, 2022.

(51) Int. Cl. B60N 2/60

(52) U.S. Cl. CPC B60N 2/6009; B60N 2/6027; B60N 2/6036

(57) ABSTRACT

Vehicle door guards can be used in conjunction with a vehicle seat cover to provide protection to doors. A vehicle door guard may include a cover portion that is configured to be secured to a lower portion and an upper portion of a vehicle seat cover via one or more couplers when the vehicle seat cover is installed on a vehicle seat. The vehicle door guard may also include one or more fasteners for supporting the cover portion from a portion of the vehicle.

### CROSS-REFERENCE TO RELATED APPLICATIONS

This application is a continuation-in-part of U.S. patent application Ser. No. 17/834,670, filed Jun. 7, 2022, which is incorporated herein by reference.

### FIELD

The present invention relates to vehicle covers for protecting the interior of a vehicle. In particular, the present invention relates to a vehicle door guard that can be used in conjunction with a vehicle seat/cargo cover to extend protection to the door and other areas to the sides of a vehicle's seat(s) and/or cargo bed.

### BACKGROUND

While there are existing interior covers for vehicles, such covers provide minimal, if any, protection to the doors and surrounding areas of the vehicle. Moreover, where covers include some form of door protection, such door protection is typically not integrated with the cover in a manner that provides sufficient coverage. For example, in many systems door covers are provided separately from seat covers, such that it is easy for spills, dirt, pet hair, or object to pass between the seat cover and the door guard to soil the door or other areas of the vehicle.

Accordingly, while there are existing interior covers, such covers have many shortcomings, including those listed above. Thus, it would be an improvement in the art to augment or even replace existing techniques with new techniques.

### BRIEF SUMMARY

The present invention extends to vehicle door guards that can be used in conjunction with a vehicle seat cover to provide protection to doors.

Thus, in some embodiments, a door guard for protecting a door of a vehicle is provided. In some cases, the door guard includes a cover portion having a top and a bottom. In some cases, the cover portion includes a coupler configured to secure the cover portion to an upper portion of a vehicle seat cover and to a lower portion of the vehicle seat cover when the vehicle seat cover is installed on a vehicle seat in a vehicle.

In some cases, the door guard includes one or more support members configured to prevent an upper edge of the door guard from sagging. In some cases, the support members extend from the top of the cover portion.

In some cases, the one or more support members include two support members. Further, some implementations are configured such that a fastening component of each of the two support members interconnect to support the cover portion from the portion of the vehicle. In some cases, the support members include one or more straps. In some cases, the straps are integrally formed as part of the support members, but in some cases they are configured to selectively couple to a base of the support members.

In some iterations, at least one of the one or more support members includes a fastening component that is configured to attach to a window of the vehicle. In some iterations, at least one of the one or more support members includes a fastening component that is configured to attach to a handle of the vehicle. Further, in some iterations, at least one of the one or more support members includes a fastening component that is configured to attach to a headrest of the vehicle.

In some implementations, the cover portion includes a support member in the form of a stiffening member (e.g., disposed within a pocket at the top of the cover portion). In some cases, the stiffening member is configured to maintain the cover portion in a planar orientation. In some implementations, the door guard is configured to be maintained in a vertical orientation by the coupler and the stiffening member independently of another type of support member (such as a strap).

In some implementations, the pocket includes an opening such that the stiffening member is selectively removable and interchangeable. In some cases, the stiffening member includes a rod made of at least one of plastic, metal, and wood.

According to some implementations, the coupler is configured such that, when it is fastened, there are no substantial gaps between the cover portion of the door guard and the upper portion of the vehicle seat cover. In some cases, there are no substantial gaps between the cover portion of the door guard and the lower portion of the vehicle seat cover. Furthermore, in some cases, there are no substantial gaps between the cover portion of the door guard and a front portion of the seat cover (the front portion being configured to cover a rear of a front seat of the vehicle).

In some implementations, the coupler includes a zipper. In some cases, the zipper is configured to open unidirectionally, whereas in some cases the zipper is configured to selectively open bidirectionally. In some cases, the zipper extends around all or part of a perimeter of the cover portion of the door guard, such as a first side edge, a bottom edge, and/or a second side edge.

According to some implementations, the door guard includes a hinge at an interface between a front portion of the vehicle seat cover and an edge of the door guard. In some cases, the hinge includes compliant material at the interface, and in some cases, it includes a coupling (in some cases permanent, and in some cases selective) between the door guard and the front portion of the vehicle seat cover.

In some cases, a vehicle protection system is provided. In some cases, the vehicle protection system includes a vehicle seat cover (including any of the vehicle seat cover components discussed herein) and a door guard (including any of the door guard components discussed herein). For example, some implementations include a vehicle seat cover having a lower portion that is configured to protect a seat portion of a vehicle seat, an upper portion that is configured to protect a back portion of the vehicle seat, and a front portion that is configured to protect a back of a front seat. Further, some implementations include a vehicle door guard having a cover portion that is configured to be secured to the upper portion and the lower portion of the vehicle seat cover (and in some cases, to the front portion of the vehicle seat cover as well) via a coupler.

In some cases, the coupler includes a zipper, and in some cases the zipper is configured as a continuous unit extending along a bottom and a side of the door guard.

According to some implementations, the vehicle seat cover and the door guard are permanently coupled together, and therefore integrated as a monolithic unit. That said, in some implementations, the door guard is selectively removable from the vehicle seat cover.

In some cases, the system selectively forms a tub- or box-shaped cover that is contained from the bottom and four sides, with no substantial gaps such that small items or animals might escape to (or damage) other portions of the vehicle.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

Understanding that these drawings depict only typical embodiments of the invention and are not therefore to be considered limiting of its scope, the invention will be described and explained with additional specificity and detail through the use of the accompanying drawings in which:

FIG. 1A provides an example of a vehicle seat cover with which a vehicle door guard can be used in accordance with one or more embodiments of the present invention;

FIG. 1B provides an example of how the vehicle seat cover of FIG. 1A can be used to protect seats of a vehicle;

FIG. 1C provides an example of how an alternative vehicle seat cover can be used to protect a seating area of a vehicle;

FIG. 2 provides an example of a stand-alone vehicle door guard used in connection with a seating area cover;

FIG. 3 provides an example of how a cover system with an integrated vehicle door guard can be used to protect an interior of a vehicle (including a door portion);

FIG. 4 provides an additional example of a cover system with another embodiment of an integrated door guard;

FIG. 5 provides another example of a cover system with an integrated door guard;

FIG. 6 provides an example of a vehicle door guard configured to be used in conjunction with a vehicle seat cover;

FIG. 7 provides an example of another vehicle seat cover with a vehicle door guard;

FIG. 8 provides an example of how the vehicle seat cover with the vehicle door guard of FIG. 7 can be used; and

FIG. 9 provides an additional example of how the vehicle seat cover with the vehicle door guard of FIG. 7 can be used.

### DETAILED DESCRIPTION

In this specification and the claims, the term “vehicle seat” should be construed as encompassing a bench seat, one or more bucket seats, and other types of vehicle seats. A vehicle seat may be configured to fold and may have multiple sections (e.g., in the case of a bench seat). A vehicle seat will be described as having a seat portion, which is the generally horizontal portion on which an individual may sit, and a back portion, which is the generally vertical portion against which an individual may support his or her back. A “vehicle seat cover” should be construed as an article that covers (or that can cover) all or a portion of a vehicle seat. For example, a vehicle seat cover may cover only the seat portion of a vehicle seat or both the seat portion and the back portion of a vehicle seat. Also, as described below, a vehicle seat cover may cover the seat portion and back portion of a rearward seat and a rear side of a back portion of a frontward seat. A vehicle seat cover may also be configured to cover a vehicle seat when the seat portion is folded up such as when the rear seat(s) of a crew cab are folded up. In such cases, the vehicle seat cover could also cover a rear side of a back portion of a frontward seat. A vehicle door guard configured in accordance with embodiments of the present invention can be used with a wide variety of vehicle seat covers to provide protection to a vehicle door and other portions of the vehicle that are positioned to the side of a vehicle seat (e.g., the trim surrounding the door).

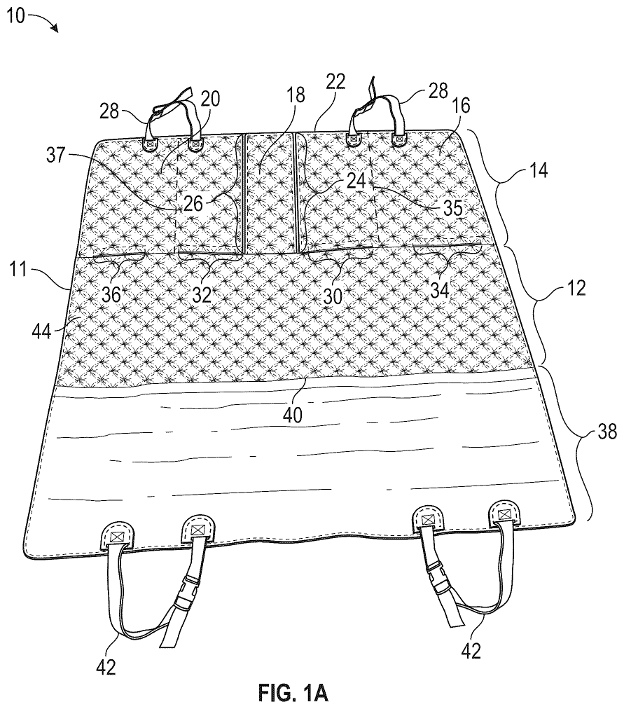

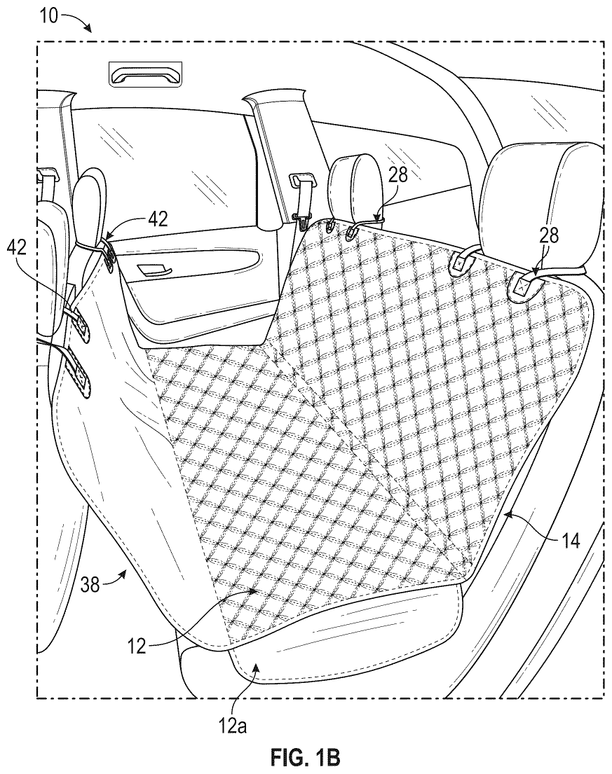

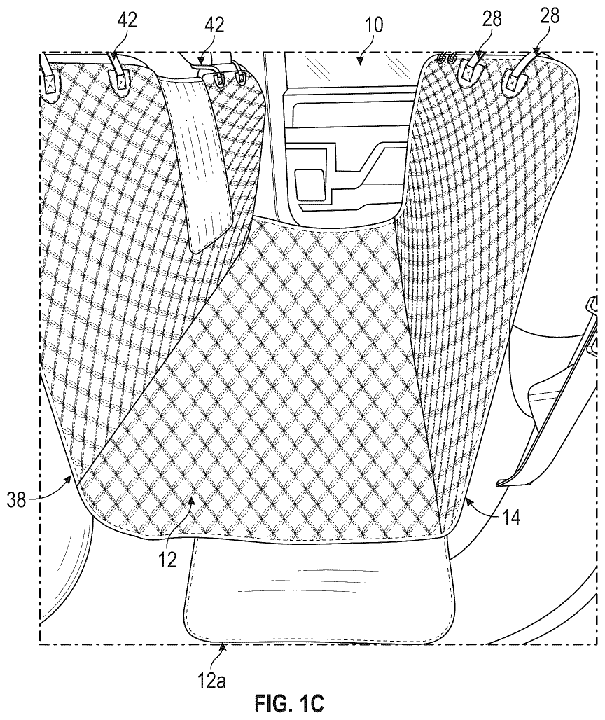

FIGS. 1A, 1B, and 1C provide examples of a vehicle seat covers 10 (or simply covers 10) with which a vehicle door guard could be used. Generally speaking, the cover 10 has an edge 11 extending around a perimeter of the cover. According to some embodiments, the cover 10 includes a lower portion 12 that is configured to cover and protect the seat portion of a vehicle seat, an upper portion 14 that is coupled to lower portion 12 and configured to cover and protect the back portion of the vehicle seat, and a front portion 38 that extends from a front edge 40 of the lower portion 12 and is configured to cover and protect the rear side of a back portion of another vehicle seat (e.g., a back of the front seat(s)). As shown in FIG. 1B, the lower portion 12, the upper portion 14, and the front portion 38 cause the cover 10 to generally resemble a hammock when installed (e.g., a generally U-shaped volume is formed by the “taco” fold of the cover 10). FIG. 1C provides an example of a vehicle seat cover 10 that is similar to the cover 10 of FIG. 1B, but is designed for use when the seat of the car is folded up in a stowed configuration. As shown, the cover 10 includes an upper portion 14, a lower portion 12, and a front portion 38, but the upper portion 14 covers the folded-up seat, the front portion 38 covers the rear portion of the rearward vehicle seat, and the lower portion rests on the floor between the rearward seat and the frontward seat. The door guards 200 discussed herein can be used with any such cover 10 configurations.

According to some embodiments, the upper portion 14 may include one or more fasteners 28 that are configured to secure/support the upper portion 14 to/from the vehicle seat (e.g., by wrapping around or otherwise coupling to the headrests of the rear or middle bench seat). Similarly, the front portion 38 may include one or more fasteners 42 that are configured to secure/support the front portion 38 to/from the other vehicle seat (e.g., by wrapping around or otherwise coupling to the headrests of the front bucket seats/bench). The fasteners 28 and 42 can be in any suitable form such as straps with buckles, hook and loop, magnets, etc.

The lower portion 12 can have a width that corresponds with the width of the vehicle seat (e.g., to extend across the entirety of the seat portion). In some embodiments, the lower portion 12 includes extensions 12a that extend outwardly from the sides of lower portion 12 and are configured to extend downwardly overtop the sides of the seat portion. In contrast, in some embodiments, the lower portion 12 does not include extensions 12a.

The upper portion 14 may also have a width that corresponds with the width of the vehicle seat (e.g., to extend across the entirety of the back portion). In some embodiments, the upper portion 14 may include one or more vertical slits that enable portions of the vehicle seat to be folded when upper portion 14 is installed. For example, in FIG. 1A, vertical slits 24 and 26 extend downwardly from an upper edge 22 of upper portion 14 and divide upper portion 14 into sections 16, 18, and 20 which may generally match the sections of the vehicle seat on which the cover 10 is intended to be used.

Openings 30, 32, 34, and 36 may be formed between upper portion 14 and lower portion 12 to allow seat belts to pass through. In some embodiments, vertical slits 24 and 26 may extend to openings 30 and 32 respectively to allow sections 16 and 20 to be folded back along fold lines 35 and 37 respectively. In this way, the upper portion 14 can accommodate vehicle seats with different folding configurations.

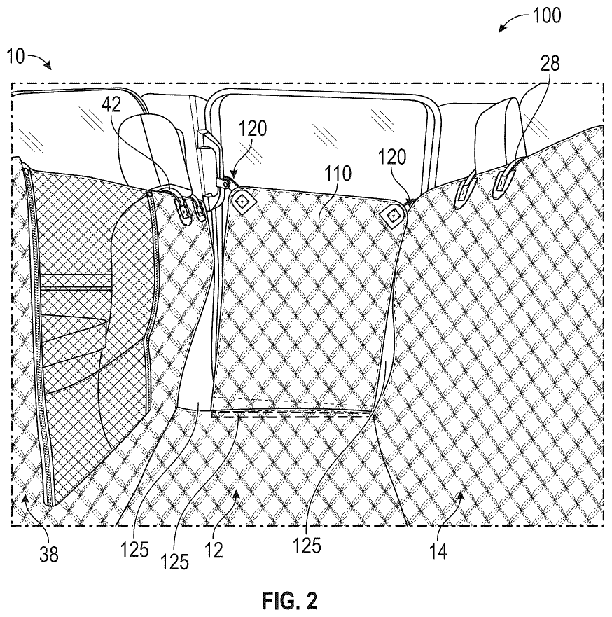

FIG. 2 provides an example of a vehicle door guard 100 (or guard 100) that is provided separately from a seat cover 10. Although the guard 100 may be useful for covering portions of a door, the guard is reliant on fasteners 120 to hold it up so that it can protect the door. Additionally, using such a cover often results in gaps 125 formed between edges of the guard and edges of the cover. Furthermore, such covers can be difficult to “open” and “close” (allowing a person or pet to enter or exit the vehicle through the door), and can often require time-consuming or inconvenient unfastening and refastening of fasteners 120.

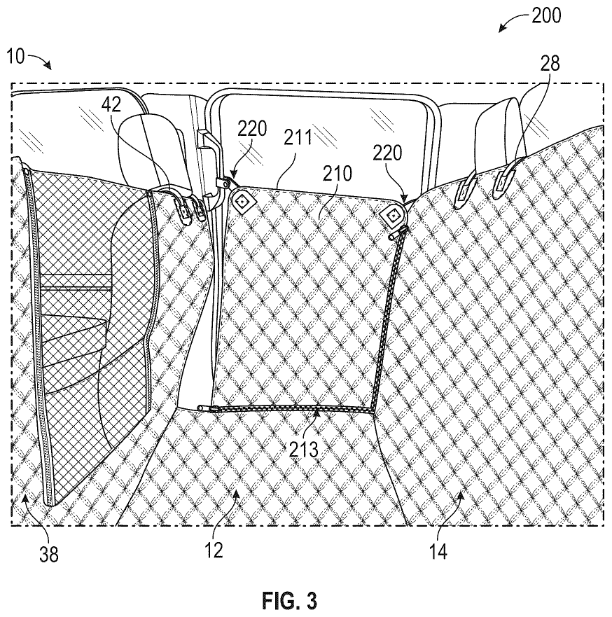

Turning to FIG. 3, FIG. 3 provides an example of an improved vehicle door guard 200 (or guard 200) configured to couple to the seat cover 10. In some embodiments, the guard 200 includes a cover portion 210 that may be made of one or more layers of a fabric material and that is configured to cover at least a portion of a vehicle door when secured to a vehicle seat cover such as the cover 10. In some embodiments, an edge 211 may extend around the cover portion 210. According to some embodiments, the edge 211 includes one or more couplers 213 configured to couple a length of the edge 211 to a length of the edge 11 of the cover 10.

Where the guard 200 includes a coupler 213, the coupler can include any suitable component for coupling the guard 200 to the cover 10, including one or more one or more eyelets, magnets, hook-and-loop fasteners, adhesives, interference fits, friction fits, tongue-and-groove connections, snaps, buttons, zippers, ties, rivets, stakes, or any other coupling mechanisms. In particular, some embodiments include one or more selective coupling mechanisms, such as hook-and-loop fasteners or zippers. By way of non-limiting illustration, FIG. 3 shows a coupler 213 in the form of a zipper.

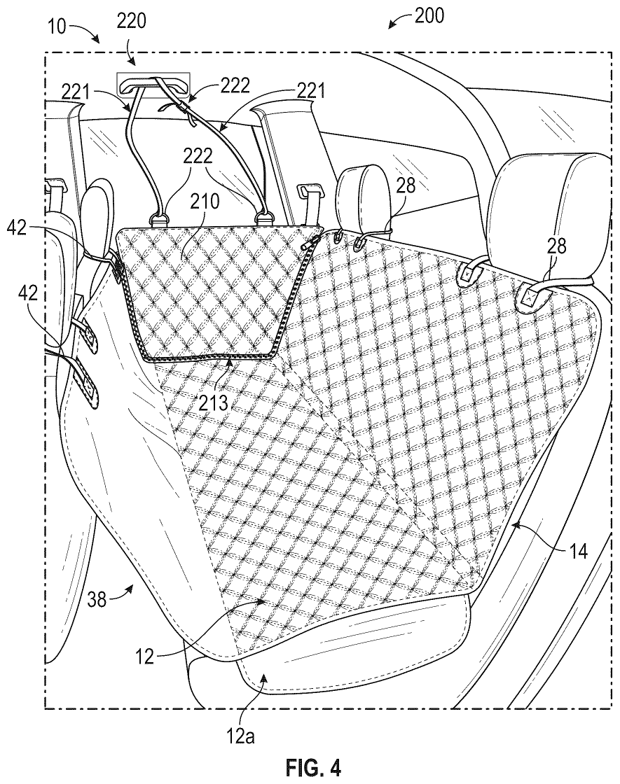

In some cases, the coupler 213 extends along (all or part of) a bottom of the cover portion 210. In some cases, the coupler 213 extends along (all or part of) one or more sides of the cover portion 210. In some cases, the coupler 213 extends as an unbroken unit along at least one of the sides and the bottom of the cover portion 210. For example, FIG. 3 shows a coupler 213 extending along one side and the bottom of the cover portion 210, while FIG. 4 shows a coupler 213 extending along a continuous path around a first side, the bottom, and a second side of the cover portion 210. By way of non-limiting illustration, FIG. 3 shows a coupler 213 in the form of a zipper that comprises a continuous unit extending along a bottom and a side of the door guard 200.

According to some embodiments, the coupler 213 includes a primary coupling component disposed on the guard 200 and a complementary coupling component disposed on the cover 10. Thus, some embodiments of the cover 10 include one or more complementary coupling components disposed along (all or part of) the edge 11 of the upper portion 14 and/or the lower portion 12 and/or the front portion 38. In such cases, the complementary coupling component can include any component configured to form a coupling together with the primary coupling component (e.g., where the coupler 213 includes a zipper, the primary coupling component can be a first row of zipper teeth and the complementary coupling component can be a second row of zipper teeth; or where the coupler 213 includes a hook-and-loop fastener, the primary coupling component can be a fastening strip of “hooks” and the complementary coupling component can be a fastening strip of “loops”).

In some embodiments, the coupler 213 is disposed such that there are no substantial gaps (a substantial gap being, for the purposes of this disclosure, anything through which a penny could fit) between the edge 11 of the upper portion 14 of the cover 10 and the corresponding edge 211 (e.g., at a first side) of the cover portion 210. In some embodiments, the coupler 213 is disposed such that there are no substantial gaps between the edge 11 of the lower portion 12 of the cover 10 and the corresponding edge 211 (e.g., at the bottom) of the cover portion 210. In some embodiments, the coupler 213 is disposed such that there are no substantial gaps between the edge 11 of the front portion 38 of the cover 10 and the corresponding edge 211 (e.g., at a second side) of the cover portion 210. In some cases, the coupler passes continuously from one or both edges to the bottom, such that there are no substantial gaps at the corners (e.g., where the upper portion 14 or the front portion 38 meets the lower portion 12 and the guard 200).

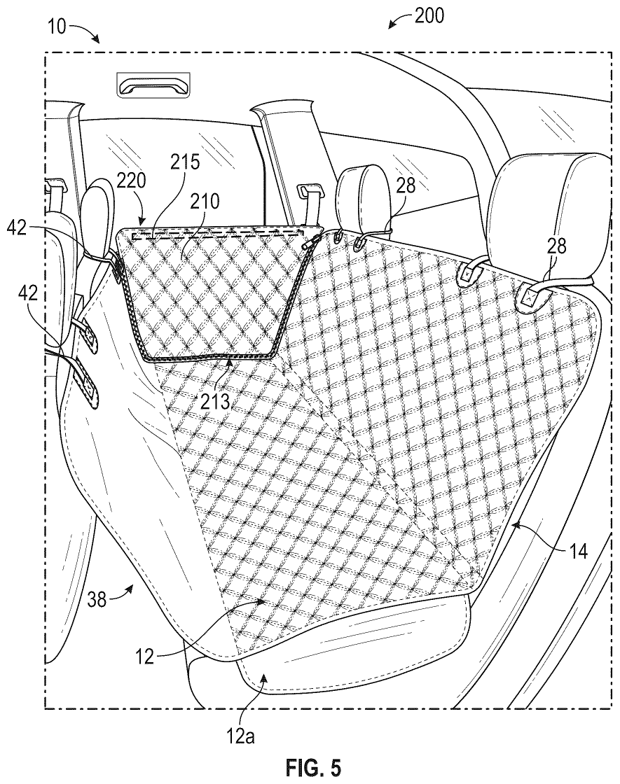

In some embodiments, the coupler 213 extends all the way to the top of the guard 200 and/or the upper portion 14 of the cover 10 one the one side, and/or in some embodiments, the coupler extends all the way to the top of the guard 200 and/or the end of the front portion 38 on the other side. In cases, the coupler 213 extends substantially to the top (e.g., within 5% of the top of the guard 200 and/or the upper portion 14 and/or the front portion 38. In some cases, the top of the guard is aligned with the top of the upper portion (e.g., they are disposed at a same height, as shown in FIG. 4) and/or the top of the front portion, and in some cases the top of the guard is substantially aligned (e.g., offset by not more than 1 inch) or largely aligned (e.g., offset by not more than 3 inches) with the top of the upper portion and/or the top of the front portion. Accordingly, in some embodiments, the top of the guard 200 is held up by virtue of the coupler 213 coupling the guard 200 to the cover 10. Thus, although some embodiments utilize support members 220 as discussed in more detail below (and as shown in FIG. 4), in some embodiments the guard 200 is configured to remain upright (thereby protecting the door) even without the use of support members (e.g., some embodiments have no support members, as shown in FIG. 5, and some embodiments have support members but are nonetheless configured to remain upright even without the support members).

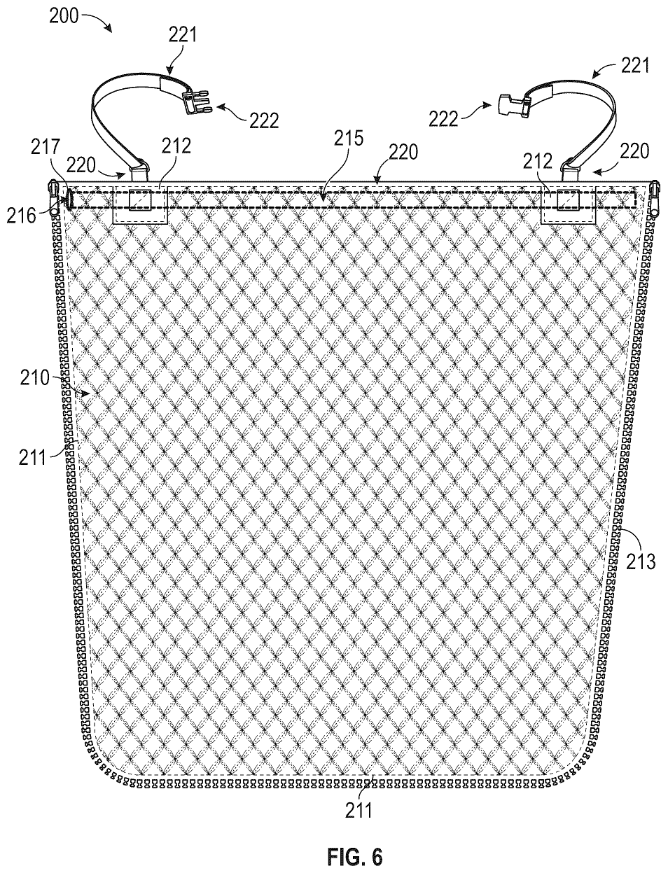

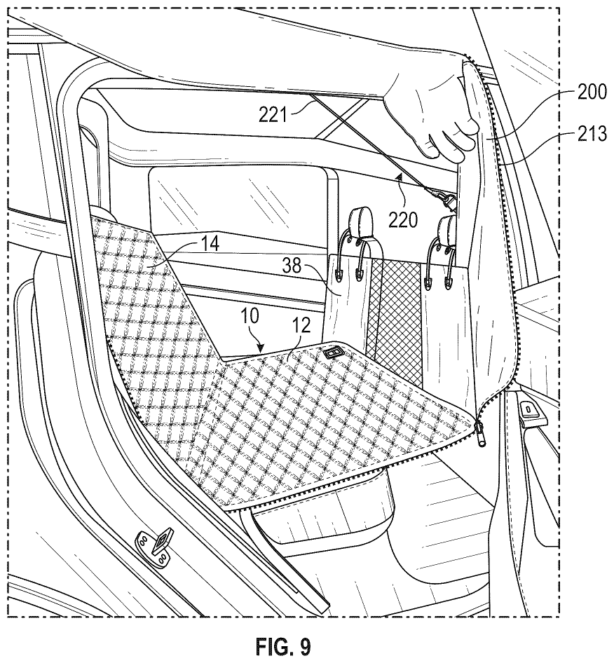

In some embodiments, the coupler is water-tight (such as by including a water-proof zipper, a water-proof coating, a water-proof flap, or another component), such that water cannot permeate through the boundary between the cover 10 and the guard 200. In some embodiments, the coupler is at least water-resistant, such that water does not easily permeate therethrough.

Where the coupler 213 includes a zipper, some embodiments of the zipper are configured to be opened only from one side, but some embodiments of the zipper are configured to be opened from either side (e.g., a zipper “slider” or pull tab is included on either side of the coupler 213, as shown in FIGS. 3 and 6, thereby allowing the coupler 213 to open bidirectionally). This can allow a number of partially open configurations that can be useful for many purposes (e.g., allowing the door guard 200 to open to the left, to the right, straight downward, or in other ways). Indeed, some embodiments of the guard 200 and/or cover 10 include one or more hinges disposed at an interface between the guard 200 and the cover 10 (which in some cases is an interface between an edge 211 of the guard 200 and an edge 11 of the cover 10, as seen in FIG. 9) to allow the guard 200 to swing open. While the hinge can be a traditional hinge (e.g., like a door hinge), some embodiments of the hinge simply include compliant portions of fabric material (e.g., of the cover portion 210 and the cover 10) coupled together (e.g., via a coupler 213) to allow for a hinge-like opening and closing of the guard 200.

Although in some embodiments the entire coupler 213 is a selective coupler (e.g., a zipper, etc., such that the door guard is selectively removable from the vehicle seat cover), in some embodiments at least a portion of the coupler 213 is permanent. For example, in some embodiments, a permanent coupling (e.g., one or more adhesives, stitches, or other permanent couplings) couples a portion of the guard 200 to the cover. For example, in some embodiments a corner of the guard (e.g., an upper corner disposed adjacent to the front portion 28 of the cover) is permanently coupled to the cover 10, and in some embodiments, the edge of the guard 200 disposed adjacent to the front portion 38 of the cover 10 is permanently coupled to the cover 10 (e.g., the guard 200 is integrally formed with the cover 10 by being permanently coupled to the front portion 38—thereby the cover 10 and the guard 200 are incorporated or permanently coupled together as a monolithic unit). Alternatively, in some cases the guard 200 is not permanently coupled to the cover 10, but the coupling between one edge 211 of the guard 200 and the front portion 38 of the cover 10 is different in nature than the coupling between the other edge 211 of the guard 200 and the upper portion 14 and/or the lower portion 12 of the cover 10. As an example, some embodiments include a first coupler 213 (e.g., including a zipper) along one edge and the bottom of the guard 200 to couple the guard 200 to the upper portion 14 and the lower portion 12 of the cover 10 (e.g., as shown in FIG. 3), but a second coupler 213 is also included (which can include any suitable type of coupler, such as hook-and-loop fastener, one or more snaps, or another type of coupler as discussed herein) for coupling the guard 200 to the front portion 38 of the cover 10.

Where the door guard 200 is permanently coupled to the seat cover 10, the coupling can be formed in any suitable manner. For example, in some cases, the two components are coupled together at a single point (e.g., by a spot stitch, a staple, or any other permanent coupling). By way of non-limiting illustration, some embodiments include a coupling at a top corner of the door guard (e.g., fixing the door guard to the front portion 38 of the cover). Some embodiments are coupled at multiple points, or along an edge (e.g., one edge of the door guard is coupled to one edge of the front portion of the cover). Regardless of the coupling mechanism, some embodiments are configured such that the coupler 213 (e.g., the zipper), is fully operational notwithstanding the permanent coupling (e.g., the bottom and right side zip open and closed, while the left side is permanently coupled).

In some embodiments, the cover 10 includes an anchor (e.g., at a boundary between the upper portion 14 and the lower portion), the anchor functioning to keep the cover coupled to the vehicle seat. For example, the anchor can include a small rod or other object that can be wedged between the seat and the back of a vehicle seat to keep the cover from coming away from the seat. The anchor can also include any component of a fastener, as described herein, or any other suitable component capable of performing an anchoring function as described. In some cases, the anchor is positioned at or near an edge 11 of the cover, such that the corner where the upper portion 14, lower portion 12, and cover portion 210 all meet, thereby enabling easier zipping and unzipping (or other coupling/uncoupling) along the corner of the door guard 200.

According to some embodiments, a guard 200 is provided on either side of the cover 10 (e.g., a first guard 200 and a second guard 200). In some such cases, the cover 10 (together with the guards 200) adopts a “tub” or “box” configuration, having a volume. While the volume can be any suitable volume (e.g., dependent on the vehicle with which the cover 10 is intended to be used), it is nonetheless highly useful (in some cases) to have a cover that is enclosed on the bottom and all four sides. For example, such a cover can better contain small pets (e.g., small dogs, cats, guinea pigs) or a large number of smaller items (e.g., papers, balls, toys, cans, water bottles, food items, or other objects), which when used in connection with other covers could typically escape through the sides or through cracks into other portions of the vehicle. Furthermore, some embodiments of the cover 10 also include a lid (which may couple to the guards 200, the upper portion 14, and/or the front portion 38 via couplers (which may include any type of couplers 38 as discussed herein). Thus, some embodiments form a fully enclosed (or largely enclosed) containment unit.

With reference to FIG. 6, some embodiments include one or more support members 220 configured to support the upper edge of the guard (and, in some cases, to couple the guard 200 to one or more portions of the vehicle). The support members 220 can be configured to support the guard in any manner, such as by coupling the guard 200 to any portion or portions of the vehicle, including ceiling handles, headrests, door handles, windows (e.g., via suction cups or otherwise), frame components, seats, or other portions of the vehicle.

In some cases, the support members 220 are formed at or towards a top of the cover portion 210. In the depicted example, support members 220 extend at a 90-degree angle from the top (e.g., they are orthogonal to the top edge). However, a support member 220 could extend from any portion of the top and at any angle. For example, opposing support members 220 could extend at a 45-degree angle from the top corners.

In some embodiments, the support members 220 include rings (or other base members or coupling components) configured to (in some cases optionally) couple to one or more straps 221. Where the support members 220 include straps 221, the straps can include any elongated component or material suitable for use in coupling the rings to one or more portions of the vehicle.

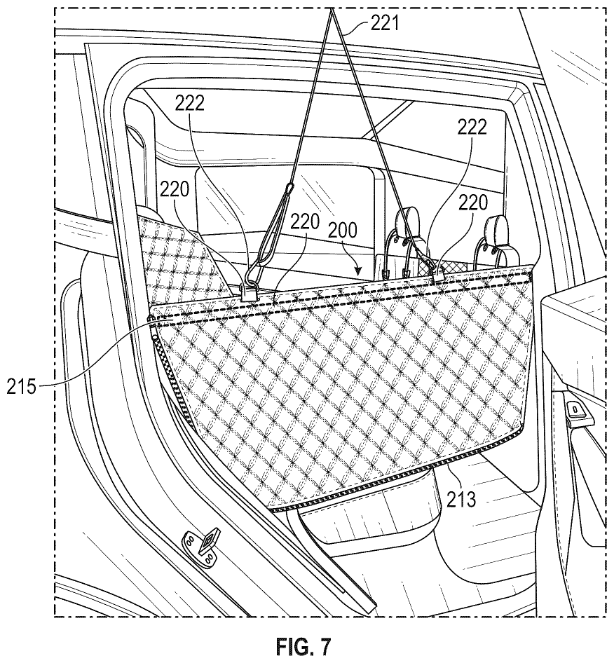

In some cases, the rings are secured to the cover portion 210 via a short piece of material (as shown in FIG. 6). In some embodiments, a reinforced section 212 may be formed on cover portion 210 and the short pieces of material may be secured to the cover portion 210 at the reinforced sections 212. Each support member 220 may also include a fastening component (or fastener) 222 that is configured to enable the corresponding strap 221 to be fastened to the other strap 221 and/or to be coupled to a fastening component 222 such as a ring and/or to a portion of the vehicle. For example, in FIG. 6, fastening components 222 are interlocking or interconnecting components of a buckle (or another interconnecting fastening component). In FIG. 7, however, the fastening components 222 are clips (e.g., carabiners, quick links, hooks, etc.) configured to hook to rings on either side of a strap 221 such that the strap can be looped around a handle or another portion of the vehicle, with either end of the strap coupled to the support members 220 of the guard 200 via the fastening components 222. In other embodiments, a fastening component 222 could be or include a suction cup for attaching strap 221 to the window, could form a buckle or other mechanical or magnetic structure for securing a strap 221 around a headrest, a handle, or other portion of the vehicle, a clip for supporting a strap 221 from the top of the window or other upwardly oriented portion of the vehicle, or any other suitable fastening component. In some embodiments, the straps 221 have an adjustable length.

FIG. 4 provides an example of how a support member 220 can be used to couple the cover portion 210 to a handle of a vehicle. The support member 220 includes a fastening component 222 in the form of a buckle, as well as fastening components in the form of rings to which a strap 221 is coupled. In contrast, FIG. 5 provides an example of a door guard 200 that does not require (indeed, it does not even have) a strap to hold it in an upright position to protect the door. Indeed, the coupler 213, in connection with a support member 220 in the form of a stiffening member 215 (as discussed in more detail below) is sufficient for retaining the guard 200 in the upright position. In some such embodiments, the door can be opened without removing the guard 200, and the guard continues to act as a barrier (unless selectively opened) as shown in FIG. 7.

The door guard 200 can have any suitable shape. In some embodiments, the cover portion 210 may have a generally square or generally rectangular shape. However, a cover portion 210 may have different shapes and sizes such as based on the type of vehicle with which it is intended to be used. For example, cover portion 210 may have a width that generally corresponds with the width of lower portion 12 and a height that is sufficient to ensure that cover portion 210 extends up to (and possibly beyond) the window of the vehicle's door when cover portion 210 is secured to lower portion 12. Moreover, as shown in FIG. 5, some embodiments of the door guard are contoured to align with a contour of the vehicle seats. For example, as seen in FIG. 6, some embodiments of the cover portion 210 are wider at top than at bottom such that cover portion 210 has a generally trapezoidal shape. For example, the side of the cover portion 210 towards the rear may closely align with the angle of the back portion of the rear seat. The other side of the cover portion can have a less-steep angle, or even an acute angle, to more closely align with the back of the seat backs on the other side (e.g., the angle at which the front portion 38 of the cover 10 is likely to be disposed, given that the front seats are often at least somewhat reclined. Thus, in some cases, the shape of the cover portion 210 of the door guard 200 generally resembles a parallelogram or other skewed polygon.

In some embodiments, the guard 200 does not extend past the upper portion 14, lower portion 12, and/or front portion 38 of the cover. Indeed, in some cases, the edges 211 of the cover portion 210 align with the edges 11 of the cover 10.

According to some embodiments, a top edge of the cover portion 210 is configured to be fold-resistant. Indeed, in some cases, the top edge is stiff such that it retains a rigid or semi-rigid configuration, thereby allowing the cover portion to act as a sheet of planar material, even where the cover portion is made of a soft fabric configured to provide protection and comfort to pets. For example, in some cases, the top edge has a thickened hem (e.g., the hem is folded over on itself multiple times and sewn together, thereby creating a rigid compact portion using the material of the cover portion 210). In some cases, the top edge incorporates a more rigid material (e.g., a rigid plastic, polymer material, metal material, or other rigid material to impart fold-resistant characteristics on the top edge).

In some embodiments, the guard 200 includes one or more support members 220 in the form of one or more stiffening members 215 to help maintain the cover portion 210 in a planar configuration and/or a vertical orientation and/or to prevent the upper edge of the cover from sagging. For example, in FIG. 6, a stiffening member 215 is incorporated into the cover portion 210 and extends between and past the reinforced sections 212 and the straps 221. The stiffening member 215 can help ensure that the top of the cover portion 210 remains planar regardless of how the other support members 220 (e.g., straps 221) may (or may not) be used to help support the cover portion 210. In some cases, the support member includes both one or more stiffening members 215 and one or more straps 221 (and in some cases, other support member components are used in addition to or instead of stiffening members and/or straps).

The stiffening member 215 can include any elongated component configured to help the guard 200 maintain its orientation or configuration (e.g., to be supported in a vertical orientation). For example, the stiffening member can include one or more bars, rods, beams, cylinders, dowels, or any other elongated rigid or semi-rigid material (and it can be made of wood, metal, glass, plastic, carbon fiber, polymer material, cardboard, stiff fabric, or any other material). In some embodiments, the stiffening member 215 is formed in between layers of the cover portion 210, and in some embodiments it extends along the front or rear surface of the cover portion 210. In some embodiments, a stiffening member is integrated into the cover portion 210 at other locations (e.g., at a midpoint between the bottom and the top).

In some embodiments, the stiffening member 215 is selectively removable. Indeed, some embodiments include a pocket 216 with an opening 217 into which the stiffening member 215 can be inserted or out through which the stiffening member can be removed. With such a configuration, interchangeable stiffening members 215 (e.g., having different lengths, shapes, or stiffnesses) can be used, thereby increasing the versatility and customizability of the guard 200. In many cases, the pocket is elongated or otherwise corresponds or conforms to a shape of the stiffening member.

In short, in some embodiments, the top edge of the cover portion 210 is substantially stiffer and more rigid than the remainder of the cover portion (which is flexible and foldable). Thus, the cover portion 210 can be used as a door, but it still retains its comfortable characteristics.

As mentioned above, according to some embodiments, the cover portion 210 is configured to open like a door (e.g., by swinging open to the right or to the left, using the left or right side of the coupler 213 (e.g., zipper, seam, or other coupler, while it remains coupled) as a hinge), while being continuously supported by the strap 221. Indeed, in contrast to some existing devices, the door can be opened and continuously supported by the strap without the need for removing the strap. Thus, the door can be supported, and thus out of the way, while it is open, and it can also be supported (thereby forming, in some cases, a more effective barrier) while it is closed.

It is worth mentioning that the system is able to open while a portion of the coupler 213 is still coupled, and while the strap 221 is still attached—whereas many other systems require frustrating uncoupling, time, and effort to detach a door guard. One advantage of some embodiments of the present invention is that the door guard can be opened using one hand. For example, some embodiments ensure that it is relatively simple to undo the coupler 213 (e.g., a zipper) along the side and bottom, then swing the door open, close it again, and refasten the coupler, all while using a single hand so the other hand can be used to secure a pet, hold belongings, or perform other actions desirable to do while opening and closing the door guard 210. In other words, in some embodiments, the support member 220 (whether in the form of a stiffening member 215, a strap 221, or both) prevents the upper edge of the door guard from sagging even when the vehicle door guard is detached from the vehicle seat cover, or from the upper and lower portions thereof.

In some embodiments, the rear side of cover portion 210 (i.e., the side that is configured to face the door) may be formed of or otherwise include a non-slip material. This non-slip material could minimize movement of cover portion 210 relative to the door such as when a pet may lean on or otherwise contact cover portion 210.

In some embodiments, a vehicle door guard may be a component of a vehicle seat cover. For example, cover 10 and one or more guards 200 could be provided as a vehicle protection system.

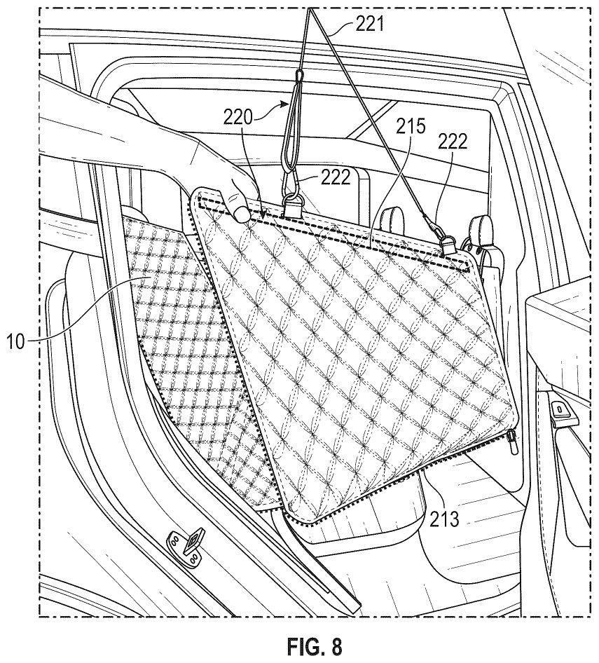

FIG. 7-9, which show views from outside the vehicle with the door open, provide examples of how the door guard 200 can be used with the cover 10. In these examples, support members 220 having a strap 221 with fastening components 222 are used to support the door guard 200 from a handle above the window. An additional support member 220 in the form of a stiffening member 215 is also used. These figures also show that a coupler 213, which is disposed along a first edge and a bottom of the door guard 200 causes the door guard 200 to itself act as a door that can be selectively opened and closed, with a second edge of the door guard acting as a hinge. Further, even though the cover portion 210 of the door guard 200 is (in these examples) soft and compliant, the stiffening member 215 allows the door guard as a whole to be retained in a planar configuration and operate as a more rigid door.

According to some embodiments, a method of using a door guard is provided. In some cases, the method includes obtaining a door guard 200. The obtaining the door guard 200 can include purchasing, manufacturing, assembling, modifying, or otherwise obtaining the door guard 200 in any suitable manner. The door guard 200 further can include any of the components discussed in connection with a door guard 200 above. In some cases, the method includes obtaining a cover 10 configured to be used in connection with the door guard 200.

In some embodiments, the method includes coupling the door guard 200 to the cover 10 via a coupler. In some cases, this includes coupling the door guard to an upper portion 14 and a lower portion 12 of the cover, and in some cases, this includes coupling the door guard to a front portion of the cover 38 as well. In some embodiments, a different coupler 213 is used to couple the upper portion 14 and the lower portion 12 than is used to couple the front portion 38, but in some cases a single coupler is used for all three.

According to some embodiments, the method includes reinforcing a top edge of a cover portion 210 of the door guard 200, or otherwise configuring the top edge to be fold resistant. In some cases, this includes coupling a stiffening member to the top edge (such as by inserting it into a pocket or otherwise disposing it at the top edge).

According to some embodiments, the method includes spending the door guard 200 from a portion of the vehicle (e.g., a handle, a ceiling, a wall, a window, or another portion of the vehicle) using a strap 221. In some cases, the strap 221 suspends the door guard 200 from a handle disposed above the window.

In some embodiments, the method includes opening the door guard 200. In some cases, opening the door guard 200 includes swinging it open to at least one of the right side and the left side, using the interface with the cover 10 on the opposite side as a hinge. In some cases, this is performed without removing the strap 221. In other words, this is performed while the door guard 200 is continuously supported by the strap 221, such that it maintains a general door configuration and is naturally biased to return to a position from which it can be easily closed (e.g., a closed position). Some embodiments of the method include closing the door guard 200, which in some cases simply consists of refastening the coupler 213 (as the door has already returned to the closed position, due to the suspension from the strap 221).

In some cases, opening the door guard 200 includes uncoupling a portion of the coupler 213 disposed adjacent to the upper portion 14 of the cover 10 and a portion of the coupler 213 disposed adjacent to the lower portion 12 of the cover 10. In some cases, this is done without uncoupling a portion of the coupler 213 disposed adjacent to the front portion 38 of the cover 10.

According to some embodiments, the method includes performing the steps of opening and closing the door guard 200 using only one hand, as the door guard 200 is configured to allow for this.

Any and all of the components in the figures, embodiments, implementations, instances, cases, methods, applications, iterations, and other parts of this disclosure can be combined in any suitable manner. Additionally, any component can be removed, separated from other components, modified with or without modification of like components, or otherwise altered together or separately from anything else disclosed herein.

As used herein, the singular forms “a”, “an”, “the” and other singular references include plural referents, and plural references include the singular, unless the context clearly dictates otherwise. For example, reference to a fastener includes reference to one or more fasteners, and reference to couplers includes reference to one or more couplers. In addition, where reference is made to a list of elements (e.g., elements a, b, and c), such reference is intended to include any one of the listed elements by itself, any combination of less than all of the listed elements, and/or a combination of all of the listed elements. Moreover, the term “or” by itself is not exclusive (and therefore may be interpreted to mean “and/or”) unless the context clearly dictates otherwise. Similarly, the term “and” by itself is not exclusive (and therefore may be interpreted to mean “and/or”) unless the context clearly dictates otherwise. Furthermore, the terms “including”, “having”, “such as”, “for example”, “e.g.”, and any similar terms are not intended to limit the disclosure, and may be interpreted as being followed by the words “without limitation”.

In addition, as the terms “on”, “disposed on”, “attached to”, “connected to”, “coupled to”, etc. are used herein, one object (e.g., a material, element, structure, member, etc.) can be on, disposed on, attached to, connected to, or otherwise coupled to another object—regardless of whether the one object is directly on, attached, connected, or coupled to the other object, or whether there are one or more intervening objects between the one object and the other object. Also, directions (e.g., “front”, “back”, “on top of”, “below”, “above”, “top”, “bottom”, “side”, “up”, “down”, “under”, “over”, “upper”, “lower”, “lateral”, “right-side”, “left-side”, “base”, etc.), if provided, are relative and provided solely by way of example and for ease of illustration and discussion and not by way of limitation.

The described systems and methods may be embodied in other specific forms without departing from their spirit or essential characteristics. The described embodiments, examples, and illustrations are to be considered in all respects only as illustrative and not restrictive. The scope of the described systems and methods is, therefore, indicated by the appended claims rather than by the foregoing description. All changes that come within the meaning and range of equivalency of the claims are to be embraced within their scope. Moreover, any component and characteristic from any embodiments, examples, and illustrations set forth herein can be combined in any suitable manner with any other components or characteristics from one or more other embodiments, examples, and illustrations described herein.

What is claimed is:

1. A vehicle protection system comprising:
a vehicle seat cover comprising a lower portion that is configured to protect a seat portion of a vehicle seat in a vehicle, an upper portion that is configured to protect a back portion of the vehicle seat, and a front portion that is configured to protect a back of a front seat; and
a vehicle door guard comprising a cover portion that is configured to be secured to the upper portion and the lower portion of the vehicle seat cover via a coupler.

2. The vehicle protection system of claim 1, wherein the coupler comprises a zipper.

3. The vehicle protection system of claim 2, wherein the zipper comprises a continuous unit extending along a bottom and a side of the door guard.

4. The vehicle protection system of claim 1, wherein the vehicle seat cover and the door guard are permanently coupled together as a monolithic unit.

5. The vehicle protection system of claim 1, wherein the door guard is selectively removable from the vehicle seat cover.

6. The vehicle protection system of claim 1, wherein an upper edge of the cover comprises a support member configured to prevent the upper edge from sagging.

7. The vehicle protection system of claim 6, wherein the support member comprises a stiffening rod.

8. The vehicle protection system of claim 6, wherein the support member comprises a strap coupled to a portion of the vehicle.

9. The vehicle protection system of claim 6, wherein the support member prevents sagging when the vehicle door guard is detached from the upper and lower portions of the vehicle seat cover.

10. The vehicle protection system of claim 1, wherein the coupler secures the vehicle door guard to the front portion of the vehicle seat cover.

11. The vehicle protection system of claim 1, wherein the coupler is configured such that, when it is fastened, there are no substantial gaps between the coupler and the upper portion of the vehicle seat cover.

12. The vehicle protection system of claim 2, wherein the zipper is configured to selectively open bidirectionally.

13. The vehicle protection system of claim 7, wherein the upper edge comprises a pocket from which the stiffening member is selectively removable.

14. The vehicle protection system of claim 8, wherein the upper edge comprises one or more fasteners to which the strap is coupled.

15. The vehicle protection system of claim 1, further comprising a hinge at an interface between the front portion of the vehicle seat cover and the door guard.

16. The vehicle protection system of claim 6, wherein the support member maintains the upper edge in a horizontal orientation independently of a fastener.

17. A method for using a vehicle door guard, the method comprising:
obtaining the vehicle door guard, the vehicle door guard comprising:
a cover portion having a top and a bottom, the cover portion being configured to attach to a lower portion and an upper portion of a vehicle seat cover when the vehicle seat cover is installed on a seat portion of a vehicle seat in a vehicle via a coupler comprising a continuous unit along a bottom and a side of the cover portion;
coupling the cover portion to the vehicle seat cover;
supporting an upper edge of the cover portion to prevent sagging; and
opening the vehicle door guard by partially uncoupling the cover portion from the vehicle seat cover and swinging the door guard open horizontally.

18. The method of claim 17, wherein supporting the upper edge comprises coupling a support member to the upper edge of the cover portion.

19. The method of claim 18, wherein the support member is a stiffening rod.

20. The method of claim 17, wherein support member is a strap suspended from a portion of the vehicle.
